(19) United States
(12) Patent Application Publication
(10) Pub. No.: US 2007/0113738 A1
(43) Pub. Date: May 24, 2007

(54) PURGE-CONTROL POLYMER-MEMBRANE-TYPE AIR DRIER SYSTEM

(76) Inventor: Tomoya NAKANO, Yokohama-shi, Kanagawa (JP)

Correspondence Address: OSTROLENK FABER GERB & SOFFEN, 1180 AVENUE OF THE AMERICAS, NEW YORK, NY, 100368403, US

(21) Appl. No.: 11/562,515

(22) Filed: Nov. 22, 2006

(30) Foreign Application Priority Data
Nov. 24, 2005 (JP) 2005-338101

(51) Int. Cl. B01D 53/22; B01D 59/12

(52) U.S. Cl. 96/4

(57) ABSTRACT

Air is dehumidified in a polymer-membrane-type air drier and sent to an air tool in which air is employed for various purposes. A selector valve is connected to the air drier and a purge-control valve connected to a purge outlet of the air drier. When the air tool is not used to allow air pressure in the selector valve to become greater than a certain value, air is sent to the purge-control valve from the selector valve, which is closed to make it impossible for air from the purge outlet of the air drier to be purged through the purge-control valve.

### BACKGROUND OF THE INVENTION

The present invention relates to a purge-control polymer-membrane-type air drier system in which air is introduced inside a polymer membrane to dehumidify air thereby controlling purging from a polymer-membrane-type air drier.

A polymer membrane comprising polymer through which vapor is permeable is placed in a casing. Wetted compressed air is supplied into the polymer membrane to allow only vapor to permeate therethrough to provide dehumidified air. Such polymer-membrane-type air drier is known.

The polymer-membrane-type air drier having no moving part is small, light and durable without electric energy, and provides high dew point which is advantageous. The polymer-membrane-type air drier is installed in various types of equipment.

In such a polymer-membrane-type air drier, for continuous dehumidification, it is necessary to keep outside of the polymer membrane in low partial pressure outside the polymer membrane. Thus, dried air is partially decompressed to decrease relative humidity and sent outside a polymer membrane to generate pressure difference in vapor. Thereafter, dried air is purged together with vapor which permeates through a polymer membrane. It is generally employed.

In the purged air, dehumidified and compressed air is partially employed. Considerable amount of dehumidified and dried air which could reach to about 30% is consumed without use for primary purpose to cause energy loss.

If air which is dehumidified and dried is not consumed, it will not necessary to purge dried air. For example, in JP3,276,784B2 and JP3,429,698B2, depending on whether or not dried air from a polymer membrane is used for primary purpose or discharge pressure of dried air, an electric signal is forwarded to a control device by a flow sensor or pressure-detecting means to allow an outlet of purged air to open and close with an electromagnetic valve.

There are some disadvantages in the device in which an electric signal and control device are used.

(a) The structure becomes complicate to increase cost.

(b) Inspection, maintenance and adjustment need a lot of time.

(c) Waiting power is required, which is uneconomical. It is likely to cause fire. It is not usable depending on the field of application.

(d) It is difficult to discharge and stop purging. Energy is uselessly consumed.

### SUMMARY OF THE INVENTION

In view of the disadvantages in the prior art, it is an object of the present invention to provide a purge-control polymer-membrane-type air drier system in which a control valve is automatically operated via a selector valve based on pressure of discharged dried air depending on whether or not dried air from a polymer-membrane-type air drier is used thereby purging dried air in the polymer-membrane-type air drier without use of electric signals or control device and stopping purging.

### BRIEF DESCRIPTION OF THE DRAWINGS

The features and advantages of the invention will become more apparent from the following description with respect to embodiments as shown in accompanying drawings wherein:

FIG. 1 is a diagram showing the first embodiment of a system according to the present invention in which an air tool is used;

FIG. 2 is a diagram showing the first embodiment of a system according to the present invention in which the air tool is not used;

FIG. 3 is a diagram showing the second embodiment of a system according to the present invention in which an air tool is used; and

FIG. 4 is a diagram showing the third embodiment of a system according to the present invention in which the air tool is not used.

### DETAILED DESCRIPTION OF PREFERRED EMBODIMENT

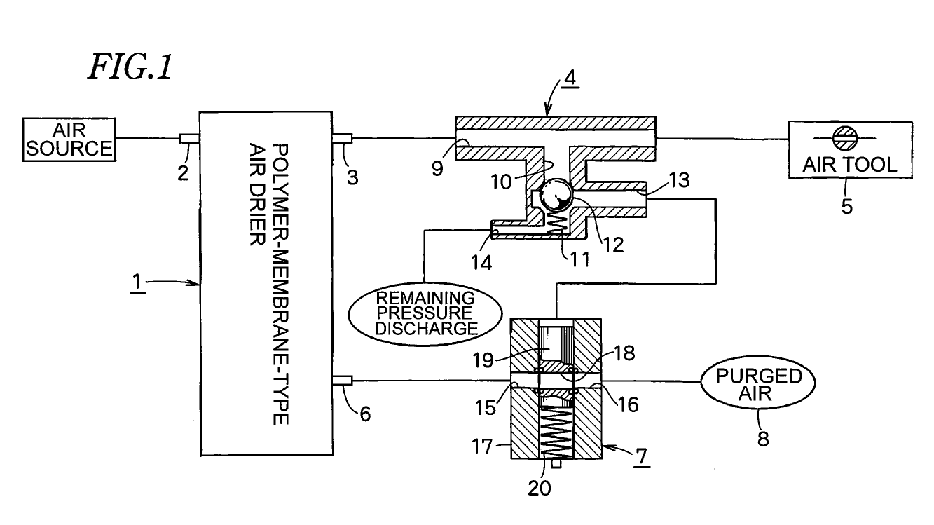

FIG. 1 shows the first embodiment according to the present invention in which an air tool 5 is used.

For simplification, the internal structure and description of a polymer-membrane-type air drier 1 are omitted. Air which flows into an inlet 2 of a polymer-membrane-type air drier 1 is dehumidified and forwarded from an outlet 3 of the sir drier 1 via a selector valve 4 to an air tool 5 in which dried compressed air is used such as an air cylinder. Dehumidified air 1 is partially sent from a purging outlet 6 to a purge-control valve 7 and discharged therefrom as purged air 8.

The selector valve 4 such as a directional control valve has a through hole 9 which connects the outlet 3 to the air tool 5, and a branching hole 10 which communicates with the through hole 9. The branching hole 10 has a ball valve 12 which is pressed by a spring 11 to close the branching hole 10 and communicates with a guide hole 13 and a remaining-pressure discharge hole 14.

The purge-control valve 7 such as a sluice valve has a sliding valve element 19 in a tubular body 17 having radial holes 15,16 which extends radially and a communicating hole 18 which extends radially to coincide with the radial holes 15,16. The sliding valve element 19 is forced upward by a spring 20.

The sliding valve element 19 moves upward in the tubular body 17 by the spring 20 with no load to allow the communicating hole 18 to communicate with the radial holes 15,16.

The guide hole 13 of the selector valve 4 is connected to an upper space of the tubular body 17 of the purge-control valve 7. While dehumidified air from the polymer-membrane-type air drier 1 is used in the air tool 5, static pressure of dehumidified air in the through hole 9 of the selector valve 4 is low, so that the ball valve 12 is pushed upwards by the spring 1 to make it impossible for the radial holes 10 to communicate with the guide hole 13.

As shown in FIG. 1, the sliding valve element 19 of the purge-control valve 7 is kept to rise by the spring 20 to allow the communicating hole 18 to communicate with the radial holes 15,16, so that air from the purging outlet 6 is discharged.

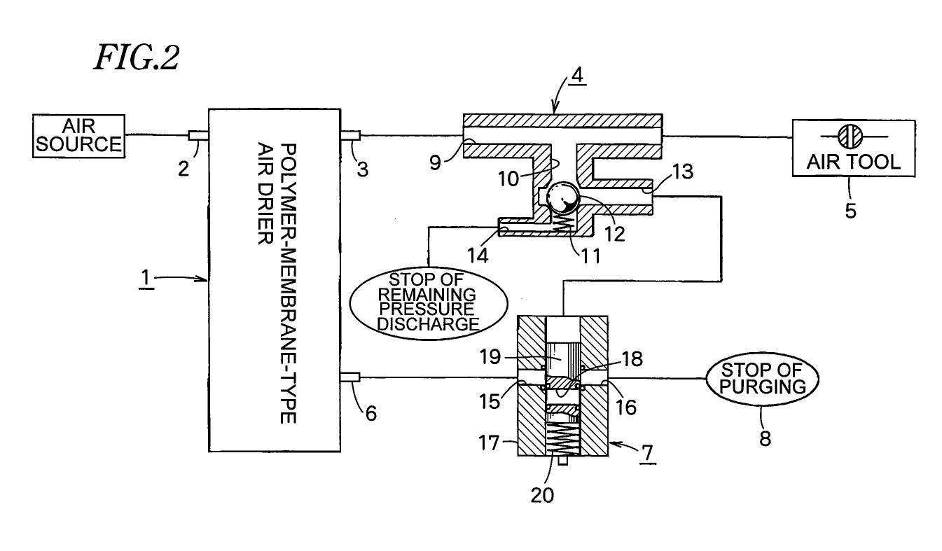

In FIG. 2, the air tool 5 is not used to allow static pressure of dehumidified air in the selector valve 4 between the outlet 3 and the air tool 5 to become greater. Dehumidified air partially flows from the branching hole 10 to the purge-control valve 7 via the guide hole 13 to push the ball valve 12 down against the spring 11. Thus, the sliding valve element 17 lowers to push the spring 20 to make it impossible for the radial holes 15,16 to communicate, so that purging stops.

When the ball valve 12 of the selector valve 4 is pushed down to allow the guide hole 13 to communicate with the through hole 9, the remaining-pressure discharge hole 14 is closed by the ball valve 12, so that the guide hole 13 is blocked off air.

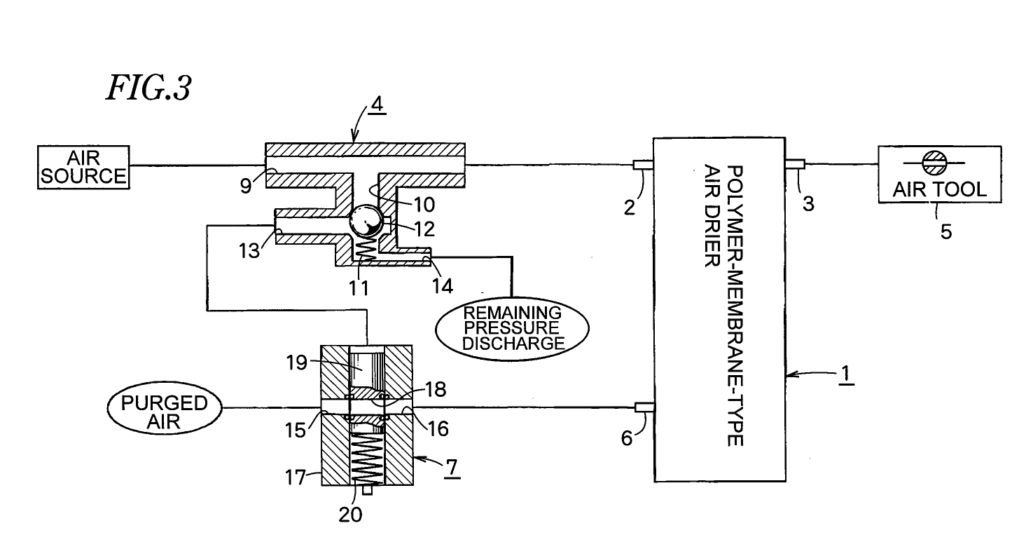

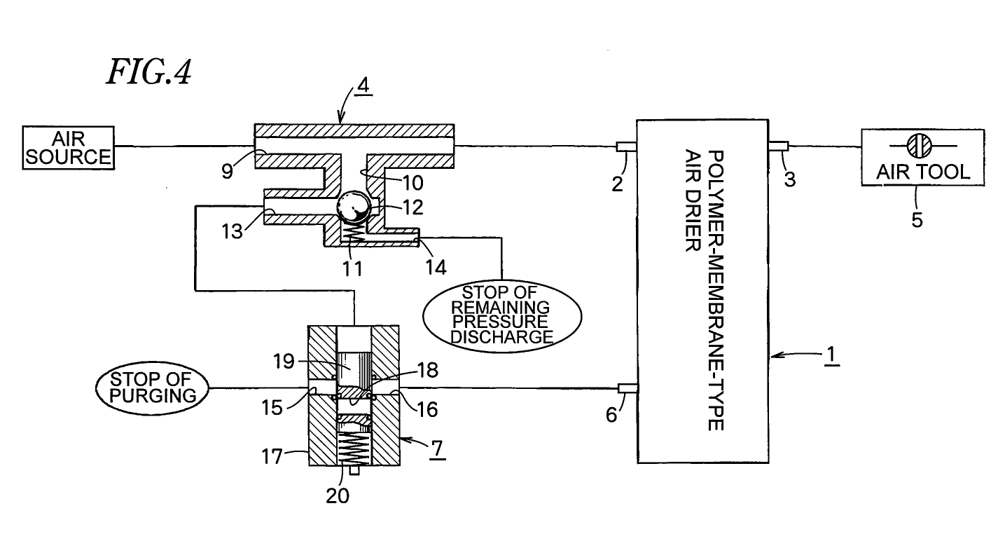

FIGS. 3 and 4 show the second embodiment of the present invention in which a selector valve 4 is provided in front of a polymer-membrane-type air drier 1, which only differs from FIGS. 1 and 2. The same numerals are allotted to the same members as those in FIGS. 1 and 2 and its description is omitted

The foregoing merely relates to embodiments of the invention. Various changes and modifications may be made by a person skilled in the art without departing from the scope of claims wherein:

What is claimed is:

1. A purge-control polymer-membrane-type air drier system comprising:
an air source;
a polymer-membrane-type air drier having an inlet connected to the air source; an outlet and a purging outlet, said air drier demoisturizing air from the air source;
a selector valve connected to the outlet of the air drier;
an air tool connected to the selector valve; and
a purge-control valve connected to the selector valve and the purging outlet of the air drier to purge air, air being purged from the purging outlet of the air drier via the purge-control valve when the air tool is used, while air is not purged when the air tool is not used.

2. An air drier of claim 1 wherein the selector valve has a guide hole connected to the purge-control valve and a ball valve forced by a first spring in the guide hole, said purge-control valve having a sliding valve element forced by a second spring and a communicating hole connected to the purging outlet of the air drier, pressure of air in the selector valve becoming greater to push down the ball valve against the first spring to allow air to flow to the purge-control valve through the guide hole to push down the valve element to close the communicating hole to make it impossible for air from the purging outlet to go out of the purge-control valve.

3. An air drier system of claim 1 wherein the selector valve comprises a directional control valve and the purge-control valve comprises a sluice valve.

4. An air drier system of claim 2 wherein the selector valve has a remaining-pressure discharge hole which communicates with the first communicating hole of the selector valve when air is sent to the air tool, the discharge hole being closed by the ball valve when air in the selector valve becomes greater than a certain value.

5. A polymer-membrane-type air drier comprising:
an air source;
a selector valve connected to the air source;
a polymer-membrane-type air drier having an inlet connected to the selector valve; an outlet and a purging outlet, said air drier dehunidifying air from the air source via the selector valve;
an air tool connected to the outlet of the air drier; and
a purge-control valve connected to the selector valve and the purging outlet of the air drier, air being purged from the purging outlet via the purge control valve when the air tool is used, while air is not purged when the air tool is not used.

6. An air drier of claim 5 wherein the selector valve has a guide hole connected to the purge-control valve and a ball valve forced by a first spring in the guide hole, said purge-control valve having a sliding valve element forced by a second spring and a communicating hole connected to the purging outlet of the air drier, pressure of air in the selector valve becoming greater to push down the ball valve against the first spring to allow air to flow from the purge-control valve through the guide hole to push down the valve element to close the communicating hole to make it impossible for air from the purging outlet to go out of the purge-control valve.

7. An air drier system of claim 5 wherein the selector valve comprises a directional control valve and the purge-control valve comprises a sluice valve.

8. An air drier system of claim 6 wherein the selector valve has a remaining-pressure discharge hole which communicates with the first communicating hole of the selector valve when air is sent to the air tool, and the discharge hole being. closed when air in the selector valve becomes greater than a certain value.
